(19) United States
(12) Patent Application Publication
(10) Pub. No.: US 2022/0322281 A1
(43) Pub. Date: Oct. 6, 2022

(54) ENHANCEMENTS ON SIGNALING OF TRACKING REFERENCE SIGNAL (TRS) CONFIGURATION UPDATE FOR IDLE MODE OR INACTIVE MODE USER EQUIPMENT (UE)

(71) Applicant: MEDIATEK INC., Hsin-Chu (TW)

(72) Inventors: Yi-Ju Liao, Hsin-Chu (TW); Wei-De Wu, Hsin-Chu (TW)

(21) Appl. No.: 17/677,922

(22) Filed: Feb. 22, 2022

Related U.S. Application Data
(60) Provisional application No. 63/171,127, filed on Apr. 6, 2021.

(51) Int. Cl. H04W 68/00; H04W 76/20; H04W 72/04; H04L 1/00; H04L 5/00

(52) U.S. Cl. CPC H04W 68/005; H04W 76/20; H04W 72/042; H04L 1/0025; H04L 5/0051

(57) ABSTRACT

A method for updating tracking reference signal (TRS) configuration and/or TRS availability information to idle mode or inactive mode user equipment (UE) is proposed to reduce/minimize the signaling overhead. A UE operates in an idle mode or an inactive mode of communication with a wireless communication network, and receives a paging downlink control information (DCI) or a paging early indication (PEI) from the wireless communication network. The paging DCI or the PEI includes an indication of system information (SI) update for TRS configuration. Based on the indication of SI update for TRS configuration, the UE receives a SIB including TRS configuration from the wireless communication network. Based on the TRS configuration, the UE receives a TRS from the wireless communication network when the UE is in the idle mode or the inactive mode.

### CROSS REFERENCE TO RELATED APPLICATION

This application claims priority under 35 U.S.C. § 119 from U.S. Provisional Application No. 63/171,127, entitled “RS Availability Signaling for Idle/Inactive Mode UE with Minimized Overhead,” filed on Apr. 6, 2021, the subject matter of which is incorporated herein by reference.

### TECHNICAL FIELD

The disclosed embodiments relate generally to wireless communication systems, and, more particularly, to enhancements on signaling of tracking reference signal (TRS) configuration update for idle mode or inactive mode user equipment (UE).

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards. The next generation mobile network (NGMN) board, has decided to focus t future NGMN activities on defining the end-to-end requirements for 5G new ratio (NR) systems.

In 5G NR, various types of reference signals, including demodulation reference signals (DMRS), phase-tracking reference signals (PT-RS), sounding reference signals (SRS), c channel state information reference signals (CSI-RS), and tracking reference signals (TRS), are Introduced, and each type of reference signals serves a specific purpose. For example, IRS are sparse reference signals intended to assist connected-mode UE in time and frequency tracking, and the IRS configuration is carried in specific information element (IE) available only through radio resource control (RRC) signaling in connected mode. On the other hand, an idle-mode UE may need to receive several synchronization signal blocks (SSBs) to acquire sufficient information for time and frequency tracking before each Paging Occasion (PO) and SSB-based measurement timing configuration (SMTC) window. Since SSBs are periodic signals, idle-mode UE needs to wake up from sleep mode for several times to receive SSBs. Even though idle-mode UE's power consumption can be saved by entering sleep mode in the times where no SSB is transmitted, the constant king up for SSB reception is still inefficient in power saving.

A solution is sought.

### SUMMARY

A method for updating tracking reference signal (TRS) configuration and/or TRS availability information to idle mode or inactive mode user equipment (UE) is proposed to reduce/minimize the signaling overhead.

From UE's perspective: a UE operates in an idle mode or an inactive mode of communication with a wireless communication network, and receives a paging downlink control information (DCI) or a paging early indication (PEI) from the wireless communication network, wherein the paging DCI or the PEI comprises an indication of system information (SI) update for TRS configuration. Based on the indication of SI update for TRS configuration, the UE receives a SIB comprising TRS configuration from the wireless communication network. Based on the TRS configuration, the UE receives a TRS from the wireless communication network when the UE is in the idle mode or the inactive mode.

In one example, the SIB is recognizable only to UEs supporting idle or inactive mode TRS.

In one example, the SIB, the paging DCI, or the PEI comprises TRS availability information. The UE determines whether the TRS is present on a TRS occasion indicated by the TRS configuration based on the TRS availability information, wherein the receiving of the TRS is performed in response to determining that the TRS is present on the TRS occasion indicated by the TRS configuration. The UE stops receiving the TRS from the wireless communication network in response to determining that the TRS is not present on the TRS occasion indicated by the TRS configuration. The paging DCI or the PEI comprises an indication of SI update for TRS availability information, and the receiving of the SIB is performed based on the indication of SI update for TRS availability information.

In one example, the indication of SI update for TRS configuration is provided by bit ‘00’ of a short message indicator in the paging DCI.

In one example, the indication of SI update for TRS configuration is provided by bit ‘10’ of a short message indicator in the paging DCI and by any of bits 3 to 8 of a short message in the paging DCI.

In one example, the indication of SI update for TRS configuration is provided by one or more bits in the paging DCI, which is or are recognizable only to UEs supporting idle or inactive mode TRS.

From network's perspective: the wireless communication network transmits a paging DCI or a PEI to a UE when the UE is operating in an idle mode or an inactive mode of communication with the wireless communication network, wherein the paging DCI or the PEI comprises an indication of SI update for TRS configuration. Next, the wireless communication network transmits a SIB comprising TRS configuration to the UE, and transmits a TRS to the UE based on the TRS configuration.

In one example, the SIB is recognizable only to UEs supporting idle or inactive mode TRS.

In one example, the SIB, the paging DCI, or the PEI comprises TRS availability information that indicates to the UE whether the TRS is present on a TRS occasion indicated by the TRS configuration. The paging DCI or the PEI comprises an indication of SI update for TRS availability information, and the transmitting of the SIB is performed based on the indication of SI update for TRS availability information.

In one example, the indication of SI update for TRS configuration is provided by one of the following: bit ‘00’ of a short message indicator in the paging DCI; bit ‘10’ of a short message indicator in the paging DCI and by any of bits 3 to 8 of a short message in the paging DCI; and one or more bits in the paging DCI, which is or are recognizable only to UEs supporting idle or inactive mode TRS.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio (NR) network 100 supporting idle-mode tracking reference signal (TRS) in accordance with aspects of the current invention.

FIGS. 2A and 2B illustrate exemplary data field in a paging DCI to carry the indication of SI update for TRS configuration and/or TRS availability information in accordance with embodiments of the current invention.

FIG. 3 is a simplified block diagram of wireless devices 301 and 311 in accordance with embodiments of the present invention.

FIG. 4 illustrates the concept of providing TRS for additional power saving in accordance with one novel aspect of the present invention.

FIG. 5 illustrates the provision of a paging DCI with an indication of SI update for TRS configuration and/or availability information in accordance with one novel aspect of the present invention.

FIG. 6 illustrates UE autonomous monitoring of SI update for TRS configuration and/or availability information in accordance with one novel aspect of the present invention.

FIG. 7 is a flow chart of a method for updating TRS configuration to idle/inactive-mode UE from UE perspective in accordance with one novel aspect of the present invention.

FIG. 8 is a flow chart of a method for updating TRS configuration to idle/inactive-mode UE from network perspective in accordance with one novel aspect of the present invention.

### DETAILED DESCRIPTION

Reference will now be made in detail to some embodiments of the invention, examples of which are illustrated in the accompanying drawings.

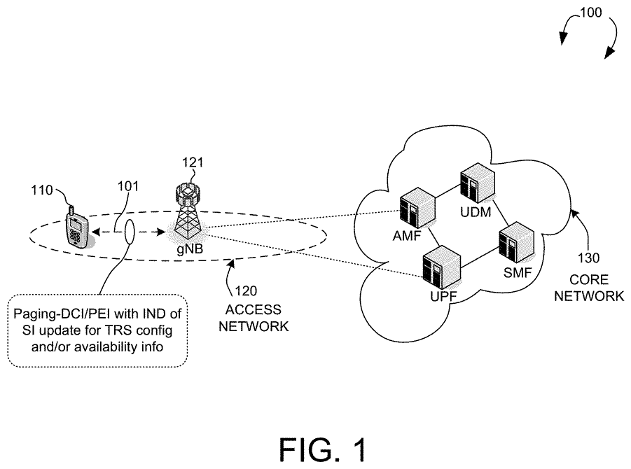

FIG. 1 illustrates an exemplary 5G new radio (NR) network 100 supporting idle-mode tracking reference signal (TRS) in accordance with aspects of the current invention. The 5G NR network 100 comprises a user equipment (UE) 110 communicatively connected to a gNB 121 operating in a licensed band (e.g., 30 GHz-300 GHz for mmWave) of an access network 120 which provides radio access using a radio access technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of things (IoT) device, and a tablet, etc. Alternatively, UE 110 may be a notebook (NB) or personal computer (PC) inserted or installed with a data card which includes a modem and radio frequency (RF) transceiver(s) to provide the functionality of wireless communication.

The gNB 121 may provide communication coverage for a geographic coverage area in which communications with the UE 110 is supported via a communication link 101. The communication link 101 between the gNB 121 and the UE 110 may utilize one or more frequency carriers to form one or more cells (e.g., a PCell and one or more SCells). The communication link 101 shown in the 5G NR network 100 may include uplink transmissions from the UE 110 to the gNB 121 (e.g., on the Physical Uplink Control Channel (PUCCH) or Physical Uplink Shared Channel (PUSCH)) and/or downlink transmissions from the gNB 121 to the UE 110 (e.g., on the Physical Downlink Control Channel (PDCCH) or Physical Downlink Shared Channel (PDSCH)). In one example, the downlink transmissions over the communication link 101 may carry the TRS configuration (which includes the information of TRS occasions, i.e., the time-frequency locations of TRS) and the TRS availability information (i.e., information concerning whether the TRS is present on a TRS occasion indicated by the TRS configuration) for UEs supporting idle/inactive mode TRS.

In accordance with one novel aspect, the downlink transmissions over the communication link 101 may carry a paging DCI or PEI which comprises an indication of SI update for TRS configuration and/or TRS availability information, when the UE 110 is operating in an idle mode (e.g., the RRC_IDLE mode) or an inactive mode (e.g., the RRC_INACTIVE mode). The idle-mode or inactive-mode UE 110 may receive a SIB comprising the updated TRS configuration and/or the updated TRS availability information based on the indication in the paging DCI or PEI. Then, the idle-mode or inactive-mode UE 110 may receive TRS from the wireless communication network based on the updated TRS configuration and/or the TRS availability information, and perform time and/or frequency tracking in the idle/inactive mode based on the received TRS.

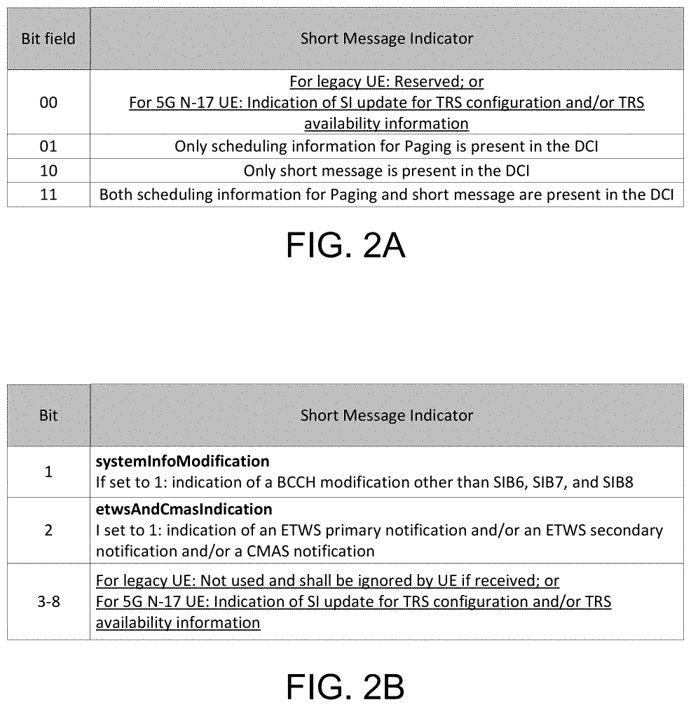

It should be appreciated that the indication of SI update for TRS configuration and/or TRS availability information may be provided by the reserved bit(s) in the paging DCI, so that legacy UEs (i.e., UEs not supporting idle/inactive mode TRS) will not process the indication and will not be triggered to perform SI update. In one example, the indication may be provided by bit ‘00’ of a short message indicator in the paging DCI, as shown in FIG. 2A. In another example, the indication may be provided by bit ‘10’ of a short message indicator in the paging DCI and by any of bits 3 to 8 of a short message in the paging DCI, as shown in FIG. 2B. Alternatively, the indication may be provided by other reserved bits (not recognizable to UEs not supporting idle or inactive mode TRS) in the paging DCI.

In accordance with another novel aspect, the SIB comprising the TRS configuration and/or TRS availability information may be a new SIB (e.g., type-15 SIB) that is recognizable only to UEs supporting idle/inactive mode TRS, so that legacy UEs (i.e., UEs not supporting idle/inactive mode TRS) do not need to receive this SIB and can stay in the sleep mode longer.

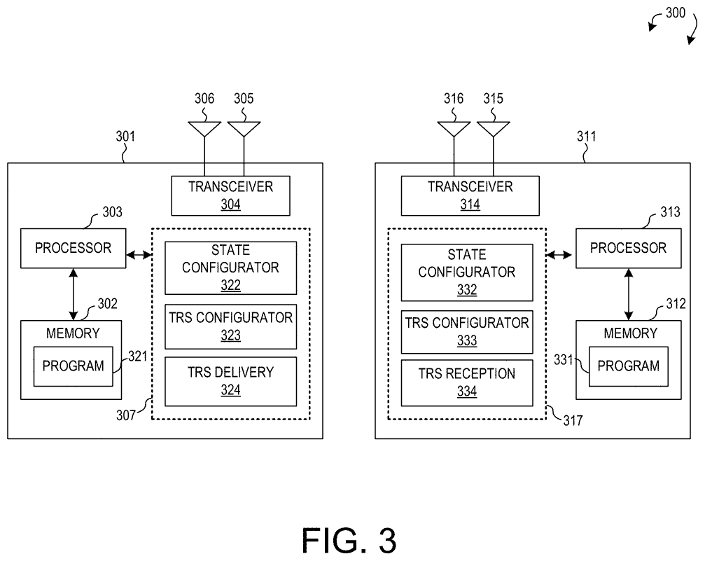

FIG. 3 is a simplified block diagram of wireless devices 301 and 311 in accordance with embodiments of the present invention. For wireless device 301 (e.g., a base station), antennae 305 and 306 transmit and receive radio signal. RF transceiver module 304, coupled with the antennae 305 and 306, receives RF signals from the antennae 305 and 306, converts them to baseband signals and sends them to processor 303. RF transceiver 304 also converts received baseband signals from the processor 303, converts them to RF signals, and sends out to antennae 305 and 306. Processor 303 processes the received baseband signals and invokes different functional modules and circuits 307 to perform features in wireless device 301. Memory 302 stores program instructions and data 321 to control the operations of wireless device 301.

Similarly, for wireless device 311 (e.g., a UE), antennae 315 and 316 transmit and receive RF signals. RF transceiver module 314, coupled with the antennae 315 and 316, receives RF signals from the antennae 315 and 316, converts them to baseband signals and sends them to processor 313. The RF transceiver 314 also converts received baseband signals from the processor 313, converts them to RF signals, and sends out to antennae 315 and 316. Processor 313 processes the received baseband signals and invokes different functional modules and circuits 317 to perform features in wireless device 311. Memory 312 stores program instructions and data 331 to control the operations of the wireless device 311.

In the wireless devices 301 and 311, the functional modules and circuits 307 and 317 can be implemented and configured to perform embodiments of the present invention. In the example of FIG. 3, the wireless device 301 is a base station (e.g., gNB) that includes a state configurator circuit 322 which configures the wireless device 311 to operate in the idle/inactive mode of communication with the wireless device 301, a TRS configurator circuit 323 which transmits an indication of SI update for TRS configuration and/or TRS availability information to the wireless device 311 (e.g., via a paging DCI or PEI), and transmits the updated TRS configuration and/or TRS availability information to the wireless device 311 (e.g., via a SIB, paging DCI, or PEI), and a TRS delivery circuit 324 which transmits the TRS to the wireless device 311 based on the updated TRS configuration and/or TRS availability information. The wireless device 311 is a UE that includes a state configurator circuit 332 which configures the wireless device 311 to operate in the idle/inactive mode of communication with the wireless device 301, a TRS configurator circuit 333 which receives the indication of SI update for TRS configuration and/or TRS availability information from the wireless device 301 (e.g., via a paging DCI or PEI), and receives the updated TRS configuration and/or TRS availability information from the wireless device 301 (e.g., via a SIB, paging DCI, or PEI), and a TRS reception circuit 334 which receives a TRS from the wireless device 301 based on the updated TRS configuration and/or TRS availability information when the wireless device 311 is in the idle/inactive mode. Note that a wireless device may be both a transmitting device and a receiving device. The different functional modules and circuits can be implemented and configured by software, firmware, hardware, and any combination thereof. The function modules and circuits, when executed by the processors 303 and 313 (e.g., via executing program codes 321 and 331), allow base station 301 and UE 311 to perform embodiments of the present invention.

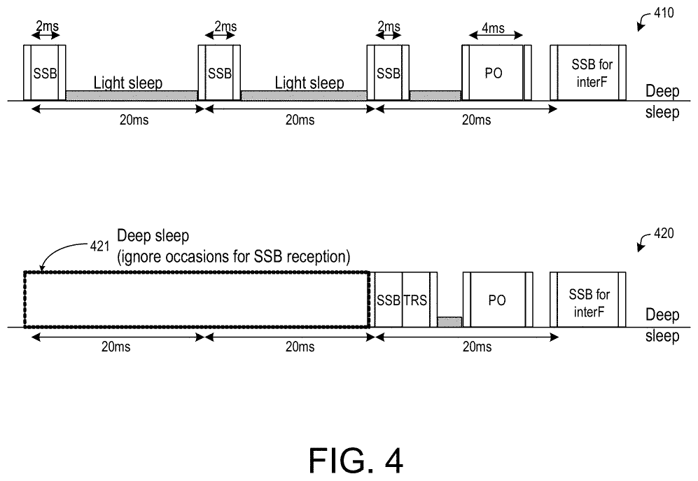

FIG. 4 illustrates the concept of providing TRS for additional power saving in accordance with one novel aspect of the present invention. Diagram 410 of FIG. 4 depicts the SSB transmission scheme in NR, where LOOP operations (including AGC, FTL, and TTL) and measurements (MEAS) can only be performed in certain occasions, e.g., during SSB bursts. UE wakes up for SSBs, e.g., every 20 ms (every 2 radio frames). UE may enter light sleep mode (e.g., a first power saving mode with higher power consumption) in the gap between the SSBs for LOOP/MEAS and paging occasion (PO). As shown in diagram 420 of FIG. 4, when TRS for idle/inactive-mode UE is introduced, UE can skip one or more occasions configured for SSB reception, e.g., entering a deep sleep mode (e.g., a second power saving mode with lower power consumption) in 421. Note that Low-SINR UEs need to wake up earlier, i.e., monitor more SSB bursts (larger NssB) before being able to decode paging message. High-SINR UEs may wake up later before PO monitoring.

To be more specific, TRS is a periodic non-zero-power (NZP)-CSI-RS-ResourceSet configured with trs-Info and composed of 2 or 4 nzp-CSI-RS-Resource. Each nzp-CSI-RS-Resource resource is 1-port and of density 3. A UE (e.g., an idle-mode UE) can be configured with one or more NZP CSI-RS set(s) with trs-info. There should be no CSI-ReportConfig for TRS (no need to report CSI for TRS). Periodic TRS can be configured with a periodicity of 10, 20, 40, or 80 ms. The bandwidth (BW) of TRS is the minimum of 52 and N_{BWP,i}^{size} resource blocks, or is equal to N_{BWP,i}^{size} resource blocks.

Moreover, although the TRS configuration received via a SIB includes the information of TRS occasions, the gNB may not always need to or want to transmit TRS on the TRS occasions indicated in the TRS configuration. For this reason, the gNB may further provide the TRS availability information to tell the idle/inactive-mode UE whether the TRS is present on a TRS occasion indicated by the TRS configuration or not. In one example, the TRS availability information may be provided to the idle/inactive-mode UE via a SIB (e.g., an existing SIB or a new SIB). In another example, the TRS availability information may be provided to the idle/inactive-mode UE via a paging DCI. Alternatively, the TRS availability information may be provided to the idle/inactive-mode UE via a PEI.

To further clarify, the TRS configuration and/or the TRS availability information may be updated. In one example, the network may provide the indication of SI update for TRS configuration and/or availability information to the idle/inactive mode UE, to trigger the UE to receive the updated SI for new TRS configuration and/or availability information. The indication may be provided in a paging DCI or a PEI. In another example, the network may not provide such indication to the idle/inactive mode UE, and the UE may autonomously monitor the SI update for TRS configuration and/or availability information.

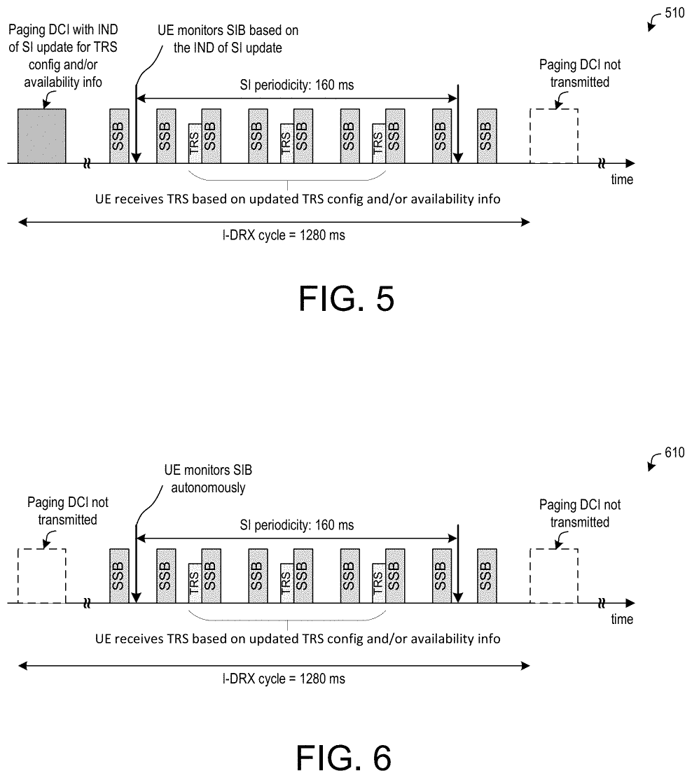

FIG. 5 illustrates the provision of a paging DCI with an indication of SI update for TRS configuration and/or availability information in accordance with one novel aspect of the present invention. Diagram 510 of FIG. 5 depicts the paging DCI provided with the indication of SI update for TRS configuration and/or TRS availability information. Based on the indication, the idle/inactive mode UE monitors the SIB (i.e., receives the SIB) and obtain the (updated) TRS configuration and/or TRS availability information. Next, the UE receives the TRS based on the (updated) TRS configuration and/or TRS availability information.

FIG. 6 illustrates UE autonomous monitoring of SI update for TRS configuration and/or availability information in accordance with one novel aspect of the present invention. Diagram 620 of FIG. 6 depicts that the network does not provide the indication (e.g., via a paging DCI) of SI update for TRS configuration and/or TRS availability information. Instead, the idle/inactive mode UE autonomously monitors the SIB (i.e., receives the SIB) and checks on any update of the TRS configuration and/or TRS availability information. It should be appreciated that, without explicit indication of SI update for TRS configuration and/or TRS availability information, the signaling overhead can be further reduced or minimized.

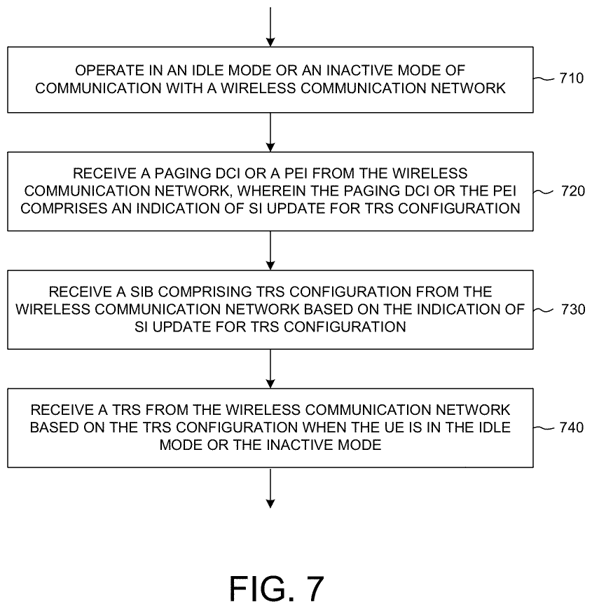

FIG. 7 is a flow chart of a method for updating TRS configuration to idle/inactive-mode UE from UE perspective in accordance with one novel aspect of the present invention. In step 710, a UE operates in an idle mode (e.g., RRC_IDLE mode) or an inactive mode (e.g., RRC_INACTIVE mode) of communication with a wireless communication network (e.g., 5G NR network). In step 720, the UE receives a paging DCI or a PEI from the wireless communication network, wherein the paging DCI or the PEI comprises an indication of SI update for TRS configuration. In step 730, the UE receives a SIB comprising TRS configuration from the wireless communication network based on the indication of SI update for TRS configuration. In step S740, the UE receives a TRS from the wireless communication network based on the TRS configuration when the UE is in the idle mode or the inactive mode.

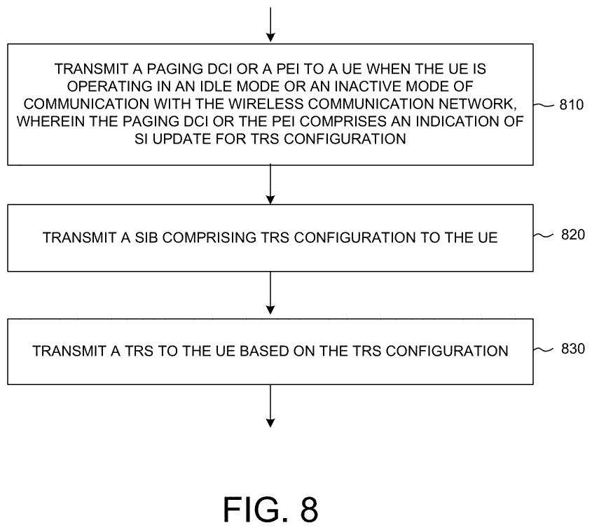

FIG. 8 is a flow chart of a method for updating TRS configuration to idle/inactive-mode UE from network perspective in accordance with one novel aspect of the present invention. In step 810, a wireless communication network transmits a paging DCI or a PEI to a UE when the UE is operating in an idle mode or an inactive mode of communication with the wireless communication network, wherein the paging DCI or the PEI comprises an indication of SI update for TRS configuration. In step 820, the wireless communication network transmits a SIB comprising TRS configuration to the UE. In step 830, the wireless communication network transmits a TRS to the UE based on the TRS configuration.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
operating in an idle mode or an inactive mode of communication with a wireless communication network by a user equipment (UE);
receiving a paging downlink control information (DCI) or a paging early indication (PEI) from the wireless communication network, wherein the paging DCI or the PEI comprises an indication of system information (SI) update for tracking reference signal (TRS) configuration;
receiving a system information block (SIB) comprising TRS configuration from the wireless communication network based on the indication of SI update for TRS configuration; and
receiving a TRS from the wireless communication network based on the TRS configuration when the UE is in the idle mode or the inactive mode.

2. The method of claim 1, wherein the SIB is recognizable only to UEs supporting idle or inactive mode TRS.

3. The method of claim 1, wherein the SIB, the paging DCI, or the PEI comprises TRS availability information.

4. The method of claim 3, further comprising:
determining whether the TRS is present on a TRS occasion indicated by the TRS configuration based on the TRS availability information;
wherein the receiving of the TRS is performed in response to determining that the TRS is present on the TRS occasion indicated by the TRS configuration.

5. The method of claim 4, further comprising:
stopping receiving the TRS from the wireless communication network in response to determining that the TRS is not present on the TRS occasion indicated by the TRS configuration.

6. The method of claim 3, wherein the paging DCI or the PEI comprises an indication of SI update for TRS availability information, and the receiving of the SIB is performed based on the indication of SI update for TRS availability information.

7. The method of claim 1, wherein the indication of SI update for TRS configuration is provided by bit ‘00’ of a short message indicator in the paging DCI.

8. The method of claim 1, wherein the indication of SI update for TRS configuration is provided by bit ‘10’ of a short message indicator in the paging DCI and by any of bits 3 to 8 of a short message in the paging DCI.

9. The method of claim 1, wherein the indication of SI update for TRS configuration is provided by one or more bits in the paging DCI, which is or are recognizable only to UEs supporting idle or inactive mode TRS.

10. A user equipment (UE), comprising:
a communication operation circuit that configures the UE to operate in an idle mode or an inactive mode of communication with a wireless communication network;
a receiver circuit that receives a paging downlink control information (DCI) or a paging early indication (PEI) from the wireless communication network, wherein the paging DCI or the PEI comprises an indication of system information (SI) update for tracking reference signal (TRS) configuration;
wherein the receiver circuit further receives a system information block (SIB) comprising TRS configuration from the wireless communication network based on the indication of SI update for TRS configuration; and
a TRS reception circuit that receives a TRS from the wireless communication network based on the TRS configuration when the UE is in the idle mode or the inactive mode.

11. The UE of claim 10, wherein the SIB is recognizable only to UEs supporting idle or inactive mode TRS.

12. The UE of claim 10, wherein the SIB, the paging DCI, or the PEI comprises TRS availability information.

13. The UE of claim 12, wherein the UE determines whether the TRS is present on a TRS occasion indicated by the TRS configuration based on the TRS availability information, and stops receiving the TRS from the wireless communication network in response to determining that the TRS is not present on the TRS occasion indicated by the TRS configuration; and the receiving of the TRS is performed in response to determining that the TRS is present on the TRS occasion indicated by the TRS configuration.

14. The UE of claim 12, wherein the paging DCI or the PEI comprises an indication of SI update for TRS availability information, and the receiving of the SIB is performed based on the indication of SI update for TRS availability information.

15. The UE of claim 10, wherein the indication of SI update for TRS configuration is provided by one of the following:
bit ‘00’ of a short message indicator in the paging DCI;
bit ‘10’ of a short message indicator in the paging DCI and by any of bits 3 to 8 of a short message in the paging DCI; and
one or more bits in the paging DCI, which is or are recognizable only to UEs supporting idle or inactive mode TRS.

16. A method, comprising:
transmitting a paging downlink control information (DCI) or a paging early indication (PEI) to a user equipment (UE) by a wireless communication network when the UE is operating in an idle mode or an inactive mode of communication with the wireless communication network, wherein the paging DCI or the PEI comprises an indication of system information (SI) update for tracking reference signal (TRS) configuration;
transmitting a system information block (SIB) comprising TRS configuration to the UE; and
transmitting a TRS to the UE based on the TRS configuration.

17. The method of claim 16, wherein the SIB is recognizable only to UEs supporting idle or inactive mode TRS.

18. The method of claim 16, wherein the SIB, the paging DCI, or the PEI comprises TRS availability information that indicates to the UE whether the TRS is present on a TRS occasion indicated by the TRS configuration.

19. The method of claim 18, the paging DCI or the PEI comprises an indication of SI update for TRS availability information, and the transmitting of the SIB is performed based on the indication of SI update for TRS availability information.

20. The method of claim 16, wherein the indication of SI update for TRS configuration is provided by one of the following:
bit ‘00’ of a short message indicator in the paging DCI;
bit ‘10’ of a short message indicator in the paging DCI and by any of bits 3 to 8 of a short message in the paging DCI; and
one or more bits in the paging DCI, which is or are recognizable only to UEs supporting idle or inactive mode TRS.
